(19) United States
(12) Patent Application Publication
(10) Pub. No.: US 2025/0385820 A1
(43) Pub. Date: Dec. 18, 2025

(54) VARIABLE DENSITY DMRS FOR PDCCH PRUNING ENHANCEMENTS

(71) Applicant: QUALCOMM Incorporated, San Diego, CA (US)

(72) Inventors: Weimin DUAN, San Diego, CA (US); Gabi SARKIS, San Diego, CA (US); Mahmoud TAHERZADEH BOROUJENI, San Diego, CA (US); Jing JIANG, San Diego, CA (US); Kangqi LIU, San Diego, CA (US)

(21) Appl. No.: 18/744,523

(22) Filed: Jun. 14, 2024

(51) Int. Cl. H04L 27/26; H04L 5/00; H04W 72/23

(52) U.S. Cl. CPC H04L 27/2613; H04L 5/0048; H04L 27/2649; H04W 72/23

(57) ABSTRACT

This disclosure provides methods and apparatuses for efficient decoding of control resource sets (CORESETs) and power saving in User Equipment (UEs) using variable density Demodulation Reference Signals (DMRS). In some examples, a UE obtains, from a network entity, a configuration of a DMRS mapping pattern to resource elements of a CORESET, with the DMRS mapping pattern indicating a variable DMRS density. This density may be dependent upon a relative orthogonal frequency division multiplexing (OFDM) symbol index within the CORESET, or an aggregation level allocated for a physical downlink control channel (PDCCH) in the CORESET. Based at least in part on this DMRS mapping pattern, the UE may perform early detection of the presence or absence of the PDCCH, allowing for early termination of PDCCH monitoring and saving power. If the PDCCH is present, the UE receives from the network entity one or more downlink control information (DCIs) in the CORESET.

### TECHNICAL FIELD

The present disclosure relates to wireless communication, and more particularly, to wireless communication systems that utilize variable density Demodulation Reference Signals (DMRS) for Physical Downlink Control Channel (PDCCH) pruning enhancements.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, where the apparatus is a user equipment (UE). The apparatus includes one or more memories, and one or more processors each communicatively coupled with at least one of the one or more memories. The one or more processors, individually or in any combination, are operable to cause the apparatus to obtain a configuration of a demodulation reference signal (DMRS) mapping pattern to resource elements of a control resource set (CORESET). The DMRS mapping pattern indicates at least one of: a first DMRS density dependent upon a relative orthogonal frequency division multiplexing (OFDM) symbol index within the CORESET, or a second DMRS density dependent upon an aggregation level allocated for a physical downlink control channel (PDCCH) in the CORESET. The one or more processors, individually or in any combination, are also operable to cause the apparatus to receive one or more downlink control information (DCIs) in the CORESET based at least in part on the DMRS mapping pattern.

Another innovative aspect of the subject matter described in this disclosure may be implemented in a method of wireless communication performable at a UE. The method includes obtaining a configuration of a DMRS mapping pattern to resource elements of a CORESET, where the DMRS mapping pattern indicates at least one of: a first DMRS density dependent upon a relative OFDM symbol index within the CORESET, or a second DMRS density dependent upon an aggregation level allocated for a PDCCH in the CORESET. The method further includes receiving one or more DCIs in the CORESET based at least in part on the DMRS mapping pattern.

Another innovative aspect of the subject matter described in this disclosure may be implemented in an apparatus for wireless communication, where the apparatus is a network entity. The apparatus includes one or more memories, and one or more processors each communicatively coupled with at least one of the one or more memories. The one or more processors, individually or in any combination, are operable to cause the apparatus to send a configuration of a DMRS mapping pattern to resource elements of a CORESET. The DMRS mapping pattern indicates at least one of: a first DMRS density dependent upon a relative OFDM symbol index of the CORESET, or a second DMRS density dependent upon an aggregation level allocated for a PDCCH in the CORESET. The one or more processors, individually or in any combination, are also operable to cause the apparatus to transmit one or more DCIs in the CORESET based at least in part on the DMRS mapping pattern.

Another innovative aspect of the subject matter described in this disclosure may be implemented in a method of wireless communication performable at a network entity. The method includes sending a configuration of a DMRS mapping pattern to resource elements of a CORESET, where the DMRS mapping pattern indicates at least one of: a first DMRS density dependent upon a relative OFDM symbol index within the CORESET, or a second DMRS density dependent upon an aggregation level allocated for a PDCCH in the CORESET. The method further includes transmitting one or more DCIs in the CORESET based at least in part on the DMRS mapping pattern.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a control resource set (CORESET) including demodulation reference signals (DMRSs).

FIG. 5 is a diagram illustrating an example of a CORESET including a variable density DMRS.

FIG. 6 is a diagram illustrating another example of CORESETs each including a variable density DMRS.

FIG. 7 is a call flow diagram between a UE and a base station.

FIG. 8 is a flowchart of a method of wireless communication performable at a UE.

FIG. 9 is a flowchart of a method of wireless communication performable at a network entity.

FIG. 10 is a diagram illustrating an example of a hardware implementation for an example apparatus.

FIG. 11 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

The present disclosure addresses the challenge of reducing physical downlink control channel (PDCCH) decoding complexity on the User Equipment (UE) side in 5G/New Radio (NR) or other wireless communication systems. Traditional systems often use fixed density demodulation reference signals (DMRSs) for this purpose, which does not allow for flexibility in response to varying channel conditions or specific requirements of the UE. The use of variable density DMRS, as described in this disclosure, provides a more adaptable approach. For instance, DMRS transmission may include varied DMRS density across the time domain based on relative symbol position within a control resource set (CORESET), based on aggregation level, or based on a combination of aggregation level and relative symbol position. A DMRS resource element (RE) mapping pattern indicating this varied DMRS density may be provided via semi-static or dynamic indication. By semi-statically or dynamically adjusting the DMRS density based on relative symbol position or aggregation level, channel estimation accuracy may be enhanced while power consumption and signaling overhead may be minimized, thereby improving the performance and efficiency of 5G NR or other UEs. Moreover, this approach allows the UE to prune PDCCH candidates through the detection of the DMRS, enabling the UE to determine the presence or absence of a PDCCH as early as possible. This in turn reduces the number of blind decoding candidates of PDCCH, leading to significant power savings.

Accordingly, various aspects of the subject matter described in this disclosure relate generally to wireless communication, and more particularly to the use of variable density DMRS in 5G/NR or other UEs. Some aspects specifically relate to the use of variable density DMRS for efficient decoding and power saving in the CORESET of 5G/NR or other UEs. In various examples, apparatuses and methods are provided in which a UE obtains a configuration of a DMRS mapping pattern to resource elements of a CORESET, with the DMRS mapping pattern indicating a DMRS density that is dependent upon a relative orthogonal frequency division multiplexing (OFDM) symbol index within the CORESET including DMRS, or an aggregation level allocated for a PDCCH in the CORESET, and receives one or more downlink control information (DCIs) in the CORESET based at least in part on the DMRS mapping pattern. Additional aspects relate to the adaptation of DMRS density based on the relative symbol position within the CORESET, the customization of DMRS density based on the aggregation level within the PDCCH, and the signaling of the DMRS RE mapping pattern through both semi-static and dynamic indications.

Thus, particular aspects of the subject matter described in this disclosure may be implemented to realize one or more potential advantages. For example, the proposed methods and apparatuses may provide enhanced efficiency and power savings in 5G/NR or other UEs by utilizing variable density DMRS for efficient decoding in the CORESET. This may be achieved by a UE obtaining the configuration of the DMRS mapping pattern, with the DMRS mapping pattern indicating the variable DMRS density dependent upon relative OFDM symbol index or aggregation level, and the UE receiving one or more DCIs in the CORESET based at least in part on the DMRS mapping pattern. In addition, the disclosed methods and apparatuses may provide a flexible approach to balance power consumption and channel estimation accuracy, optimize signaling overhead, and enhance the overall performance and efficiency of the 5G NR or other UE. These advantages can be realized through the adaptation of DMRS density based on the relative symbol position, the aggregation level, and the mapping pattern signaling.

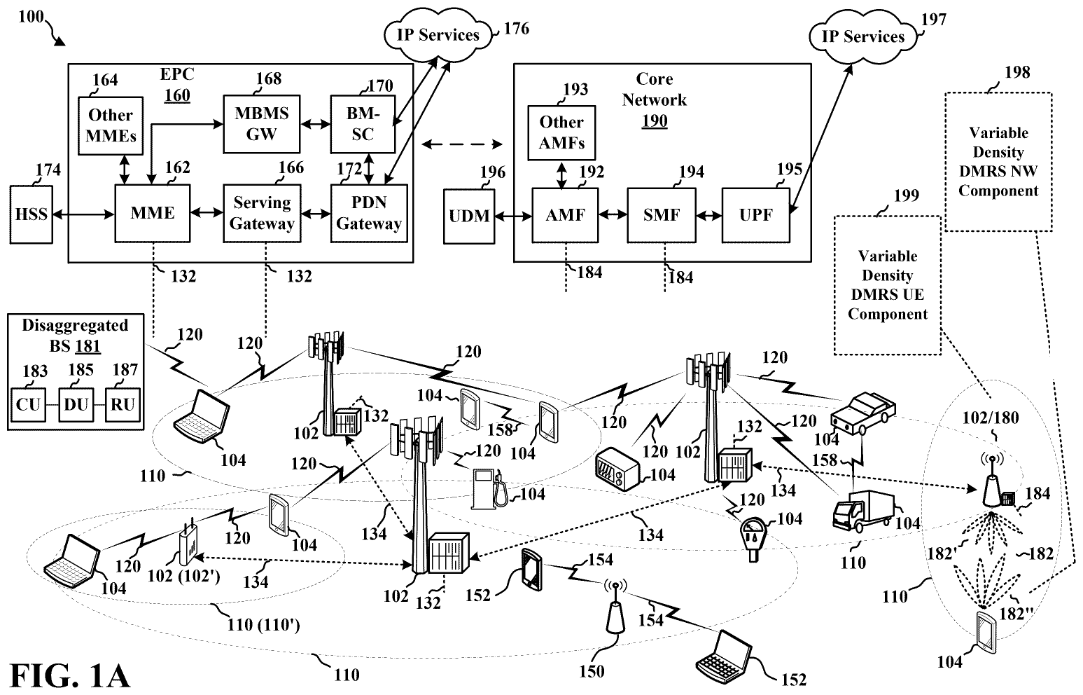

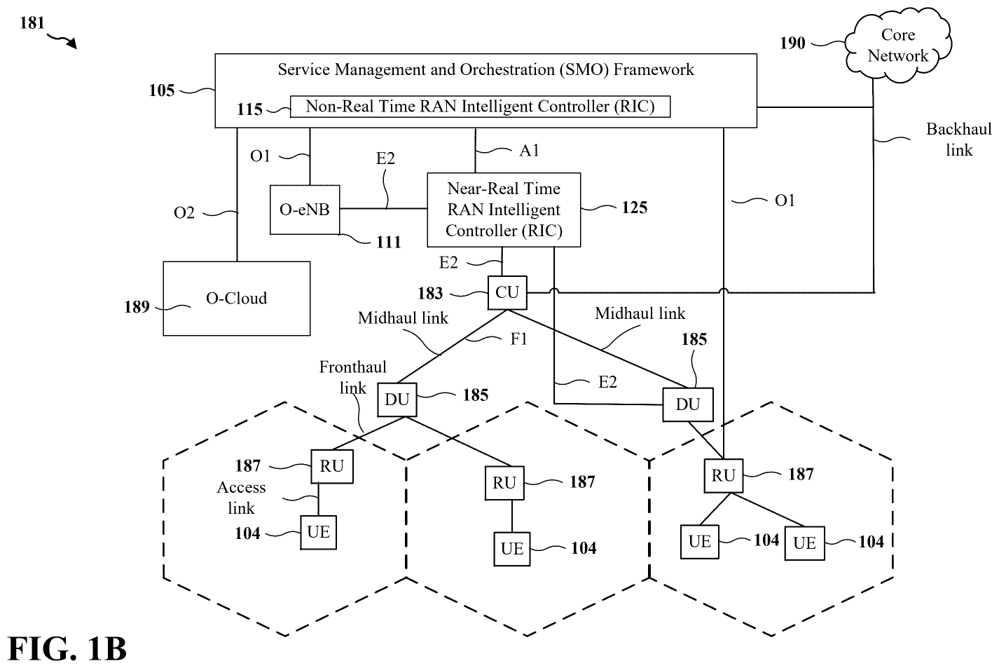

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUS 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

Referring to FIGS. 1A and 1B, in certain aspects, the UE 104 may include a variable density demodulation reference signal (DMRS) UE component 198 that is configured to obtain a configuration of a DMRS mapping pattern to resource elements of a control resource set (CORESET), the DMRS mapping pattern indicating at least one of: a first DMRS density dependent upon a relative orthogonal frequency division multiplexing (OFDM) symbol index within the CORESET, or a second DMRS density dependent upon an aggregation level allocated for a physical downlink control channel (PDCCH) in the CORESET; and receive one or more downlink control information (DCIs) in the CORESET based at least in part on the DMRS mapping pattern. The UE may obtain the configuration and receive the one or more DCIs from base station 102/180, disaggregated base station 181, a component of disaggregated base station 181 such as CU 183, DU 185, or RU 187, or some other network entity.

Furthermore, in certain aspects, a network entity such as base station 102/180, disaggregated base station 181, or a component of disaggregated base station 181 such as CU 183, DU 185, or RU 187, may include variable density DMRS network (NW) component 199 that is configured to send a configuration of a DMRS mapping pattern to resource elements of a CORESET, the DMRS mapping pattern indicating at least one of: a first DMRS density dependent upon a relative OFDM symbol index of the CORESET, or a second DMRS density dependent upon an aggregation level allocated for a PDCCH in the CORESET; and transmit one or more DCIs in the CORESET based at least in part on the DMRS mapping pattern. The network entity may send the configuration and transmit the one or more DCIs to UE 104 or a different UE.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

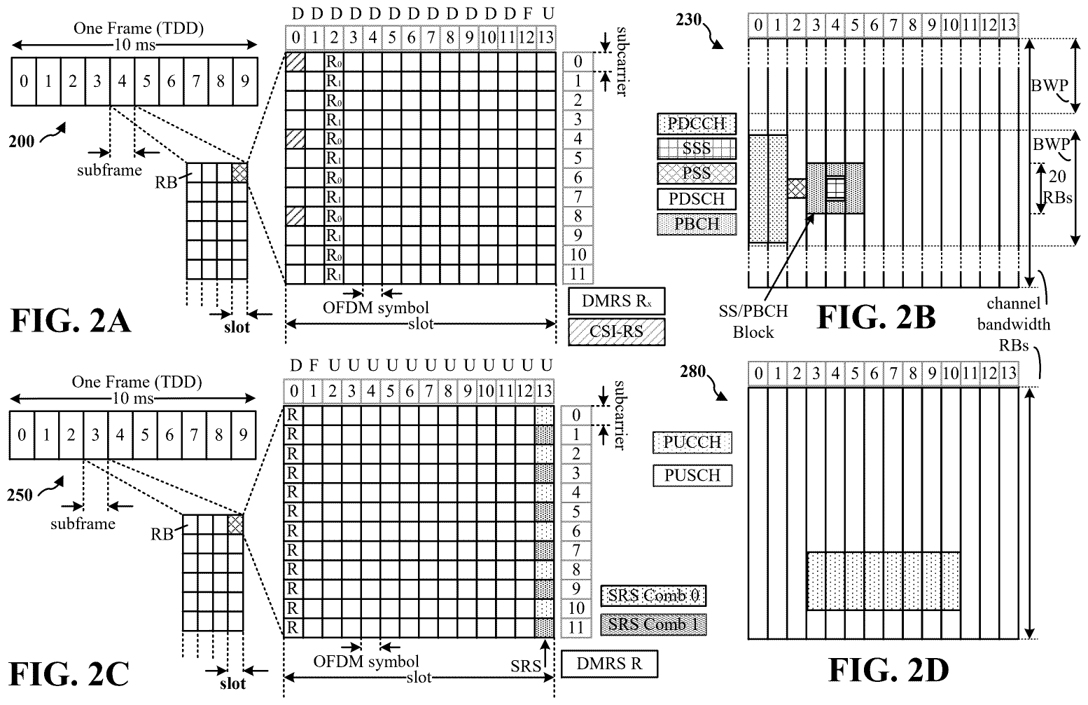

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 24 slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

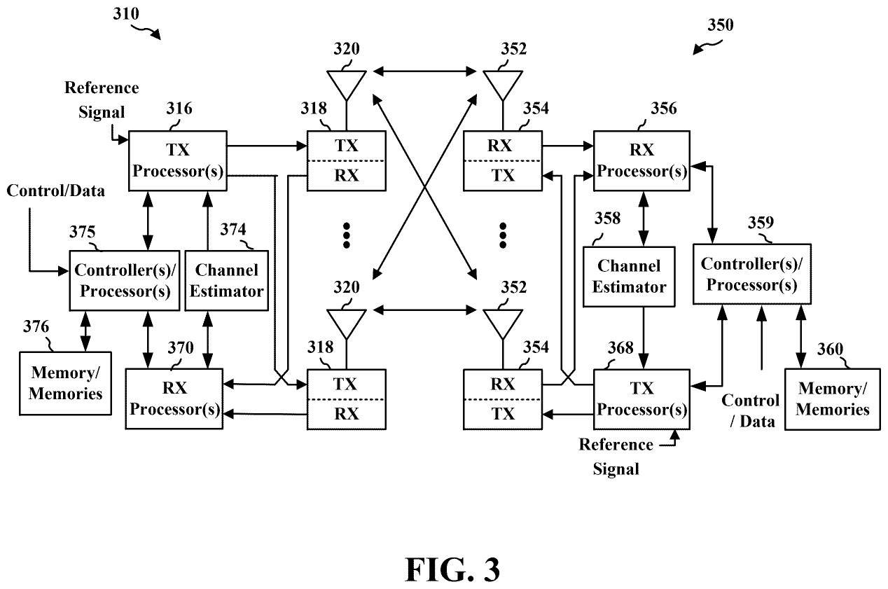

FIG. 3 is a block diagram of a base station 310 in communication with a UE 350 in an access network. In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the base station 310, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359 may be configured to perform aspects in connection with variable density DMRS UE component 198 of FIG. 1A.

At least one of the one or more TX processors 316, the one or more RX processors 370, and the one or more controller/processors 375 may be configured to perform aspects in connection with variable density DMRS NW component 199 of FIG. 1A.

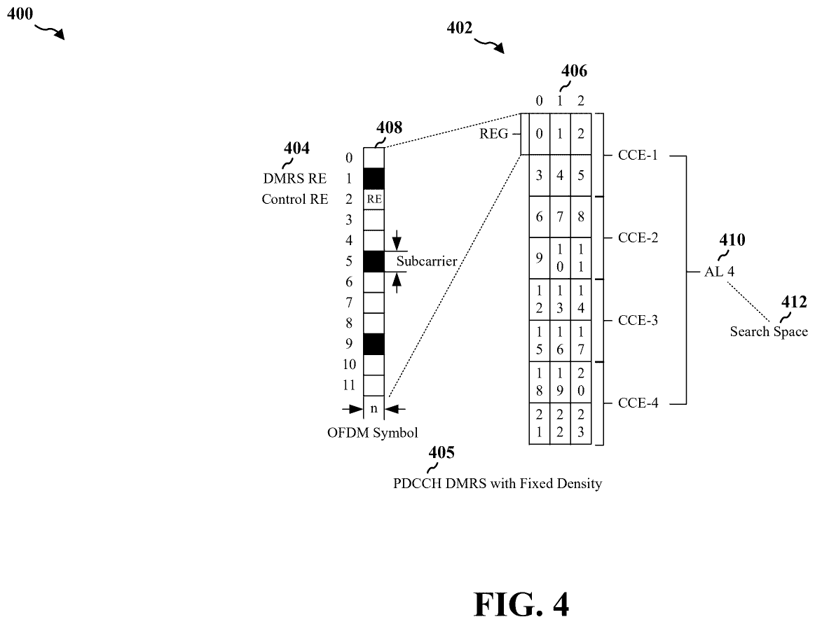

FIG. 4 illustrates an example 400 of a control resource set (CORESET 402) including demodulation reference signals (DMRSs 404). A CORESET is a set of physical resources, specifically an area on a NR downlink resource grid such as illustrated in FIGS. 2A-2D, used to carry a Physical Downlink Control Channel (PDCCH 405) and downlink control information (DCI). The CORESET in 5G is analogous to the control region in an LTE subframe. However, there is a significant difference between the two. In LTE, the control region spans the entire system bandwidth. In contrast, the CORESET in 5G is localized to a specific region in the frequency domain. The configuration of CORESETs is semi-static. Thus, the network may set a CORESET and communicate it to the UE via Radio Resource Control (RRC) reconfiguration messages. This configuration includes details about the size, location, and periodicity of the CORESET.

A CORESET's structure is composed of multiple resource blocks in the frequency domain and a number of OFDM symbols in the time domain. For example, the number of OFDM symbols may be one, two, or three. In the example 400 of FIG. 4, CORESET 402 includes three OFDM symbols having OFDM symbol indices 406 ‘0’, ‘1’, and ‘2’, although the number of OFDM symbols and symbol indices may be different in other examples. Both the frequency region and the time domain region of CORESET 402 may be defined by the RRC signaling.

A CORESET is made up of multiple levels of sub-structures. At the most basic level, there is a resource element (RE 408), which is the smallest unit of the resource grid, consisting of one subcarrier in the frequency domain and one OFDM symbol in the time domain. A resource element group (REG) is then made up of one resource block, generally including 12 resource elements in the frequency domain, and one OFDM symbol in the time domain. A control channel element (CCE) is made up of multiple REGs. An aggregation level (AL 410) indicates how many CCEs are allocated for a PDCCH. In the example 400 of FIG. 4, CORESET 402 includes an aggregation level 410 of four, with each of the four CCEs including six REGs, although the AL and number of REGs per CCE may be different in other examples.

Within a CORESET, a search space 412 is an area that the UE may monitor to detect a specific PDCCH or DCI. There are two categories of search space: common search space (CSS) and UE specific search space (USS). The type of search space a UE monitors is defined by a radio network temporary identifier (RNTI) type or RRC configuration. The size of a search space, which determines how many bits it can carry, is determined by the aggregation level 410. There are multiple different types of aggregation levels, and the size of each aggregation level in the unit of CCE may be pre-defined.

For 5G/NR and other UEs, the process of interpreting received signals to extract information, known as decoding, is a significant operation. For instance, UEs 104 may generally perform up to 44 decoding attempts per slot to check if DCI in PDCCH 405 is present in a transmission from base station 102. DCI, a type of control information transmitted from the base station to the UE in the downlink direction, carries important information such as resource allocation, transmission format, and power control commands.

The DCI is carried on the PDCCH 405. The UE typically searches for its DCI in the PDCCH without being informed in advance as to where the DCI is located, a process known as PDCCH blind detection. This blind process is computationally intensive and hence a significant source of power consumption in the UE.

To save UE power from PDCCH blind detection, a UE may perform early termination of PDCCH monitoring based on DMRS detection. DMRS 404, a type of reference signal used in 5G NR, is important for channel estimation and equalization, processes that characterize the effect of the physical channel on the transmitted signal and reverse these effects to recover the original signal, respectively. If the DMRS detection indicates that there is no DCI present, the UE may stop the decoding or PDCCH monitoring process early, saving power.

This early termination may be part of a broader strategy of early control channel (CCH) absence detection. Since DMRS processing is one of the first steps in CCH detection, the absence of CCH may be determined early in the processing pipeline. This allows for saving cycles in de-mapping (converting the received signal back into data), decoding, and post channel estimation, leading to power savings. The earlier the absence of PDCCH 405 is detected, the more power may be saved. Therefore, it is desirable to detect the absence of PDCCH as early as possible.

Another strategy for power saving is DMRS-based PDCCH pruning. Pruning refers to the process of reducing the number of potential candidates for decoding. By potentially reducing the number of blind decodes applied, DMRS-based PDCCH pruning may further reduce the area of the PDCCH processing hardware, leading to more power and area savings. Fewer decoding attempts mean less computational resources are used, which may reduce the size or area of the hardware designed for PDCCH processing.

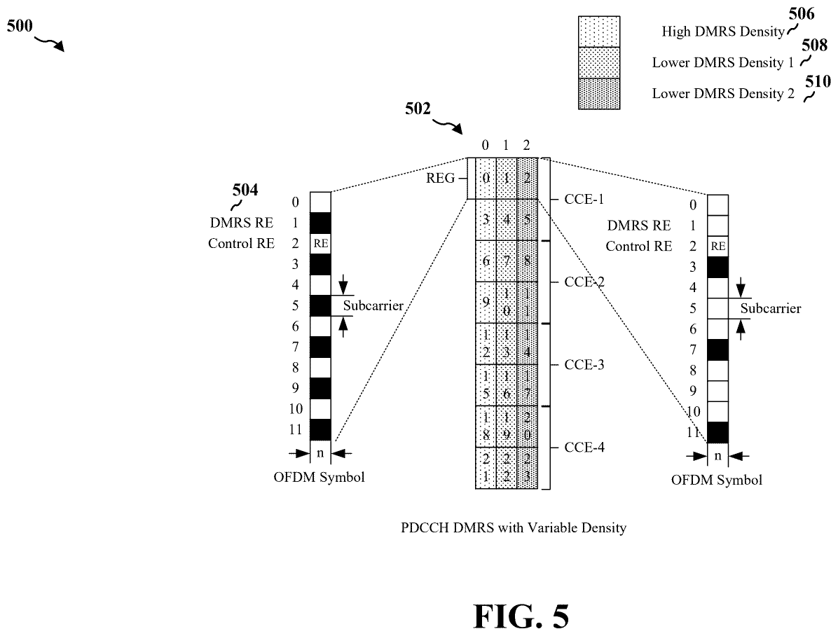

Motivated by these potential benefits, the present disclosure provides for DMRS enhancements to allow for early detection or absence of PDCCH through DMRS-based PDCCH pruning and PDCCH absence detection. In contrast to the fixed density, DMRS 404 shown in FIG. 4, variable density DMRS for PDCCH decoding may be provided, based on which DMRS the absence of PDCCH may be detected earlier. This earlier detection may lead to higher UE power savings, since the decoding process may be stopped sooner. As a result, the efficiency of the decoding process may be improved. Moreover, with DMRS-based PDCCH decoding using variable density DMRS, the number of blind decoding candidates to be searched may potentially be reduced. This reduction may, in turn, decrease the area of the UE's chipset dedicated to PDCCH processing, which is a significant consideration in hardware design. As a result, power consumption and hardware area may be reduced in the UE modem, which may lead to longer battery life and smaller, lighter devices. FIG. 5 illustrates an example 500 of a CORESET 502 including a variable density DMRS 504. In this example, CORESET 502 may correspond to CORESET 402, but instead of having DMRS 404 of a fixed density at fixed REs such as illustrated in FIG. 4, here CORESET 502 may have DMRS 504 which varies in density 506, 508, 510 across the time domain, or across different symbols of the CORESET. As in FIG. 4, CORESET 502 is a set of resources in the frequency and time domain where control information is located and PDCCH may potentially be transmitted. By using a variable density DMRS for CORESET 502, detection of the presence or absence of PDCCH may be achieved as early as possible, thereby saving UE power.

The density 506, 508, 510 of DMRS in each symbol may be controlled using a comb size. Comb size refers to the spacing between the DMRS REs in the frequency domain. A smaller comb size indicates a higher density of DMRS. For instance, if a DMRS comb size is 4, the DMRS may be transmitted every four REs in a symbol.

The base station may transmit high-density DMRS in the first or initial symbol of the CORESET 502. The first or initial symbol is a relative symbol within the CORESET, rather than an absolute symbol of the CORESET. Thus, the first or initial symbol is not limited to ‘0’, but may be any OFDM symbol index that is in the beginning of the CORESET (‘1’, ‘2’, ‘3’, or the like). DMRS density may refer to the number of DMRS REs per symbol, as indicated by the comb size. Thus, a high-density DMRS may refer to a scenario where a large number of REs are mapped to DMRS in a symbol, such as illustrated by density 506 in the first symbol of FIG. 5. A large density in the initial symbol may improve the accuracy of channel estimation as early as possible. Moreover, having more DMRS REs from higher density 506 increases UE processing gain, making it more likely to detect the DMRS as early as possible. With a large density of DMRS in the first symbol, the UE may detect the DMRS after processing the first symbol and then shut down its processing for subsequent CORESET symbols, saving power.

For high-density DMRS, the DMRS comb size may at most be equal to 4. Thus, the DMRS density 506 of the initial CORESET symbol may be configured such that no more than every four REs are mapped to DMRS 504 in a symbol of CORESET 502. For instance, in the example of FIG. 5, the first symbol may have a high-density DMRS with a comb size of 2. In the extreme case of a comb of size 1, every RE of a symbol is mapped to DMRS 504. While a comb size of 1 would result in the highest possible DMRS density 506 and thereby provide the most accurate channel estimation, this may also consume the most UE power. Thus, a comb size greater than 1 is illustrated practically for the higher DMRS density 506 in FIG. 5.

Detecting the DMRS in CORESET 502 may imply detection of the presence or absence of a PDCCH in CORESET 502. If the UE does not detect any higher density DMRS in the initial symbol, the UE may skip or refrain from the PDCCH decoding of CORESET 502. On the other hand, if the UE does detect the DMRS in the first symbol, it may continue with the PDCCH decoding of subsequent symbols of CORESET 502. Alternatively, even if the DMRS and thus the PDCCH or DCI are detected in the first symbol, the other symbols of DMRS may still be used to fully perform channel estimation to decode the PDCCH.

For the subsequent symbols of the CORESET such as symbols ‘1’ and ‘2’, or other relative subsequent symbols such as symbols ‘2’ and ‘3’ (if the initial symbol is ‘1’), ‘3’ and ‘4’ (if the initial symbol is ‘2’), or the like, the base station may transmit lower density DMRS. For instance, in the event the processing gain to the UE from the high DMRS density in the first symbol is not sufficient for detecting presence or absence of PDCCH, the base station may provide slightly less density in one or more of these other symbols for the UE to consider in PDCCH decoding. This may save power compared to the higher density DMRS of the initial CORESET symbol ‘0’, while still providing sufficient channel estimation accuracy for decoding the control information. Moreover, resources for CORESET 502 are very constrained, and so the more REs that are used to transmit DMRS in these subsequent symbols, the fewer REs that are available to transmit the control information. Lower DMRS density in these subsequent symbols may therefore account for this consideration.

The DMRS RE mapping in these subsequent relative symbols may be achieved using multiple approaches. In one approach, the base station may apply a common DMRS RE mapping with lower density 508 or 510 to these subsequent symbols than that applied for the initial symbol. Thus, the same mapping pattern may be used for all subsequent symbols of the CORESET 502. As an example, following a smaller comb size of 2 configured for initial symbol 0 (or other initial relative symbol) of CORESET 502, a larger comb size of 4, 6, or other number may be configured commonly for symbols 1 and 2 (or other subsequent relative symbols) of CORESET 502 such as illustrated in FIG. 5. This may simplify UE processing of control information. Moreover, applying the same density for the first and second symbols of CORESET 502 may provide a balance between power consumption and the availability of PDCCH resource elements for DCI. In another approach, the base station may apply a descending DMRS density in subsequent symbols of the CORESET. Thus, the DMRS density 508, 510 may be configured to decrease from one symbol to the next in CORESET 502. As an example, following a smaller comb size of 2 configured for initial symbol 0 (or other initial relative symbol) of CORESET 502, a larger comb size of 4 may be configured for symbol 1 (or other subsequent relative symbol) of CORESET 502, followed by a largest comb size of 6 for symbol 2 (or other further subsequent relative symbol) of CORESET 502. This may provide a more optimal balance between power consumption and channel estimation accuracy than the common density approach, as the DMRS density 508, 510 may be adjusted over different symbols. Moreover, more PDCCH resource elements may be available for control information in the last symbol than in the common density approach.

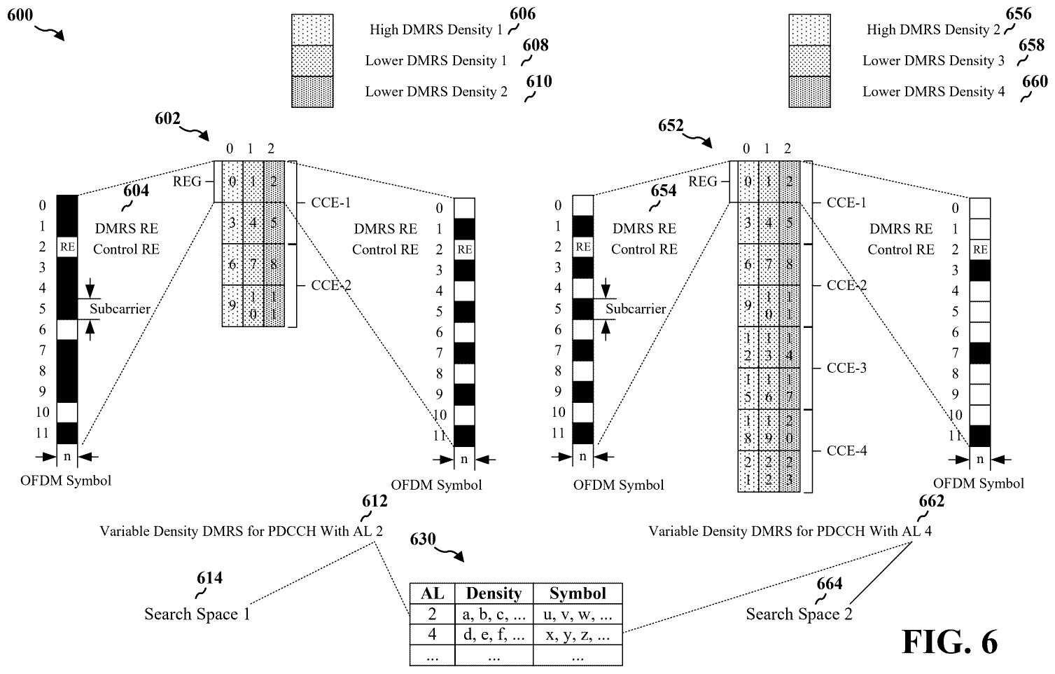

FIG. 6 illustrates an example 600 of CORESETs 602, 652 each including a variable density DMRS 604, 654. In this example, CORESETs 602, 652 may correspond to CORESET 402, but instead of having DMRS 404 of a fixed density at fixed REs such as illustrated in FIG. 4, here CORESETs 602, 652 may each have DMRS 604, 654 which varies in density 606, 608, 610, 656, 658, 660 for different aggregation levels 612, 662 of the CORESET. As in FIG. 4, CORESET 602, 652 each are a set of resources in the frequency and time domain where control information is located and PDCCH may potentially be transmitted, while aggregation level refers to the number of CCEs that are grouped together to form a single PDCCH carrying the DCI in the CORESET. By using a variable density DMRS based on different ALs for CORESET 602, 652, the system can optimize the balance between power consumption and channel estimation accuracy, leading to improved performance and efficiency of the 5G NR UE.

For different ALs 612, 662, the DMRS density 606, 656 of the first or initial symbol in the PDCCH (the relative initial symbol in the CORESET such as ‘0’, ‘1’, ‘2’, or the like) may vary. Here, as in the example of FIG. 5, the density of the DMRS may refer to the number of DMRS REs per symbol. Thus, a high-density DMRS may indicate that more REs are mapped to DMRS 604, 654, which may improve the accuracy of channel estimation but at the cost of increased power consumption. For PDCCH with lower AL 612, such as AL 2 in the example of FIG. 6, the DMRS density 606 of the initial symbol may be higher. For instance, a lower aggregation level may indicate a lower PDCCH code rate and lower reliability for decoding the PDCCH, and so the DMRS density may be configured to be higher for such AL to increase PDCCH decoding reliability. Thus, in the example of FIG. 6, the DMRS density 606 of symbol ‘0’ (or other relative initial symbol) in CORESET 602 with AL 2 may be higher than the DMRS density 656 of symbol ‘0’ (or other relative initial symbol) in CORESET 652 with AL 4 to make it easier for the UE to decode the DMRS 604 and thus determine the presence or absence of a PDCCH early in CORESET 602. Also, a lower AL PDCCH may carry less information due to having fewer resources and therefore require less power for decoding, allowing more power to be allocated to DMRS 604 for improved channel estimation.

Conversely, for PDCCH with higher AL 662, such as AL 4 in the example of FIG. 6, the DMRS density 656 of the initial symbol may be lower. For instance, a higher aggregation level may indicate a larger CORESET bandwidth and higher reliability for decoding the PDCCH, and so the DMRS density may be configured to be lower for such AL to spread DMRS REs across the larger CORESET bandwidth. Thus, in the example of FIG. 6, the DMRS density 656 of symbol ‘0’ (or other relative initial symbol) in CORESET 652 with AL 4 may be lower than the DMRS density 606 of symbol ‘0’ (or other relative initial symbol) in CORESET 602 with AL 2. Also, higher AL PDCCH may carry more information due to having more resources and therefore require more power for decoding, leaving less power available for DMRS 654.

Accordingly, the average DMRS density in a CORESET may be scaled to correspond to different CORESET bandwidths, thereby providing for consistency of DMRS densities across different aggregation levels. For example, the DMRS density for an AL 2 may be double the DMRS density for an AL 4, four times the DMRS density for an AL 8, and eight times the DMRS density for an AL 16. Similarly, the DMRS density for an AL 16 may be one eighth the DMRS density for an AL 2, one fourth the DMRS density for an AL 4, and one half the DMRS density for an AL 8.

In some examples, the DMRS density 608, 610, 658, 660 of subsequent symbols within a CORESET may be the same as or common to the DMRS density 606, 656 of the initial symbol of the CORESET, irrespective of aggregation level. For example, if DMRS density 606 for CORESET 602 with AL 2 in initial symbol ‘0’ (or other initial relative symbol) has a comb size of 2, the DMRS density 608, 610 for CORESET 602 with AL 2 in subsequent symbols ‘1’ and ‘2’ (or other subsequent relative symbols) may have a same comb size of 2 and thus a common DMRS density across the symbols. Similarly, if DMRS density 656 for CORESET 652 with AL 4 in initial symbol ‘0’ (or other initial relative symbol) has a comb size of 4, the DMRS density 658, 660 for CORESET 652 with AL 4 in subsequent symbols ‘1’ and ‘2’ (or other subsequent relative symbols) may have a same comb size of 4 and thus a common DMRS density across the symbols.

In other examples such as illustrated in FIG. 6, the DMRS density 608, 610, 658, 660 of subsequent symbols of a CORESET may be different than and less than the DMRS density 606, 656 of the initial symbol of the CORESET similar to the example of FIG. 5, irrespective of aggregation level. For example, if DMRS density 606 for CORESET 602 with AL 2 in initial symbol ‘0’ (or other initial relative symbol) has a comb size of 2, the DMRS density 608, 610 for CORESET 602 with AL 2 in subsequent symbols ‘1’ and ‘2’ (or other subsequent relative symbols) may each have a comb size of 3 or 4 and thus a different DMRS density than that of symbol ‘0’. Similarly, if DMRS density 656 for CORESET 652 with AL 4 in initial symbol ‘0’ (or other initial relative symbol) has a comb size of 3, the DMRS density 658, 660 for CORESET 652 with AL 4 in subsequent symbols ‘1’ and ‘2’ (or other subsequent relative symbols) may each have a comb size of 4 and thus a different DMRS density than that of symbol ‘0’.

In various examples, a table 630 may be defined to map DMRS density 606, 608, 610, 656, 658, 660 across AL 612, 662 and relative OFDM symbol index. This mapping table 630 may provide a pre-defined approach to determine the appropriate DMRS density for a given symbol of CORESET 602, 652 based on the AL 612, 662 and the position of the relative symbol within the PDCCH. This table 630 may indicate the DMRS densities 606, 608, 610, 656, 658, 660 in a CORESET across the time domain and may vary across different CORESETs, aggregation levels, or relative symbols such as illustrated in FIG. 6. For example, the table 630 may define the DMRS density across CORESET and relative symbol index, across aggregation level only, or across aggregation level and relative symbol index.

In some examples, if the UE is configured with multiple search spaces 614, 664 with different ALs 612, 662, then the variable DMRS density 606, 608, 610, 656, 658, 660 may be based on the minimum AL across the configured search spaces 614, 664, rather than each AL separately. This minimum AL approach allows a common variable DMRS density to be configured for different search spaces 614, 664, rather than a different DMRS density to be configured for each AL as in prior examples. This common DMRS density may also reduce the processing complexity of the UE, since the UE may be more simply able to perform one round of channel estimation across multiple ALs, rather than multiple rounds of detection including one for each AL. Also, the UE may only implement one DMRS density mapping for multiple search spaces, rather than a separate mapping for each search space, further saving UE processing complexity. Additionally, as lower ALs are configured with higher DMRS densities as previously described, this minimum AL configuration may allow the highest DMRS density for PDCCH detection to be commonly configured for each search space associated with a different AL, providing more accurate channel estimation for each AL.

In both the examples of FIGS. 5 and 6, the base station may signal the DMRS 504, 604 to the UE via a DMRS RE mapping pattern. The DMRS RE mapping pattern may refer to the arrangement of DMRS REs in the frequency and time domain. For example, the DMRS RE mapping pattern may indicate the time-frequency resources, comb size, and other resource mapping information of any of the variable density DMRS illustrated in FIG. 5 or 6. In various examples, the DMRS RE mapping pattern for a CORESET may vary across the time domain such as illustrated in FIG. 5, vary across different aggregation levels such as illustrated in FIG. 6, or vary across both the time domain and across different aggregation levels.

In one example, the DMRS RE mapping pattern may be semi-statically indicated to the UE via an RRC configuration. For instance, the DMRS RE mapping pattern may be indicated in at least one of the RRC configuration of a UE-specific CORESET, such as CORESET 502, 602, or the RRC configuration of a UE-specific search space, such as search space 614, 664. Thus, the mapping pattern may be set for a certain period that changes infrequently, which may reduce the signaling overhead and simplify UE processing compared to dynamic indications.

In another example, the DMRS RE mapping pattern may be dynamically indicated to the UE. For instance, the DMRS RE mapping pattern may be indicated in a Medium Access Control (MAC) Control Element (MAC-CE) or a DCI. In various examples, the base station may provide the DMRS RE mapping pattern in a similar manner as a slot format indicator (SFI), which indicates to the UE via DCI a change to an upcoming slot format. For example, the base station may provide an RRC configuration which indicates DMRS RE mapping related parameters, such as information in mapping table 630 of FIG. 6, and the MAC-CE or DCI may include an index to the table 630 that informs the UE how the DMRS will be mapped in CORESET 502, 602. Thus, the mapping pattern may change from one transmission to the next, for example, in response to changing channel conditions.

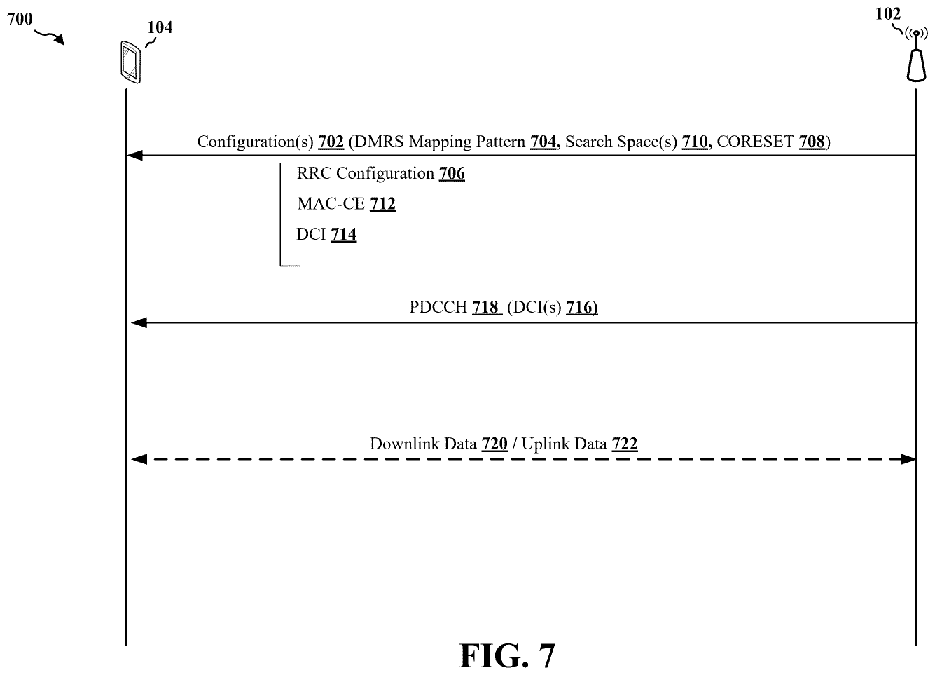

FIG. 7 illustrates an example 700 of a call flow between UE 104 and base station 102. Initially, the base station may transmit one or more configurations 702 to the UE, and the UE may receive the one or more configurations 702 from the base station. In various examples, the configuration(s) 702 may include or indicate a DMRS mapping pattern 704. For instance, the mapping pattern 704 may be a DMRS RE mapping pattern that indicates a mapping of variable density DMRS 504, 604 to resource elements of a CORESET, such as CORESET 502, 602. For example, the mapping pattern 704 may indicate any of the time-frequency resources of the DMRS 504, 604 illustrated in FIG. 5 or 6, including at least one of DMRS density 506, 508, 510 varying based on OFDM symbol index ‘0’, ‘1’, ‘2’ or other relative symbols, or DMRS density 606, 608, 610, 656, 658, 660 varying based on aggregation level 612, 662. In one example, the DMRS mapping pattern 704 may be indicated in an RRC configuration 706. For example, the DMRS mapping pattern 704 may be indicated in the same configuration as an RRC configuration for a CORESET 708 or as an RRC configuration for a search space 710. Alternatively, the CORESET 708 or the search space 710 or both may be indicated in a different RRC configuration than DMRS mapping pattern 704. In another example, the DMRS mapping pattern 704 may be indicated in a MAC-CE 712 or DCI 714.

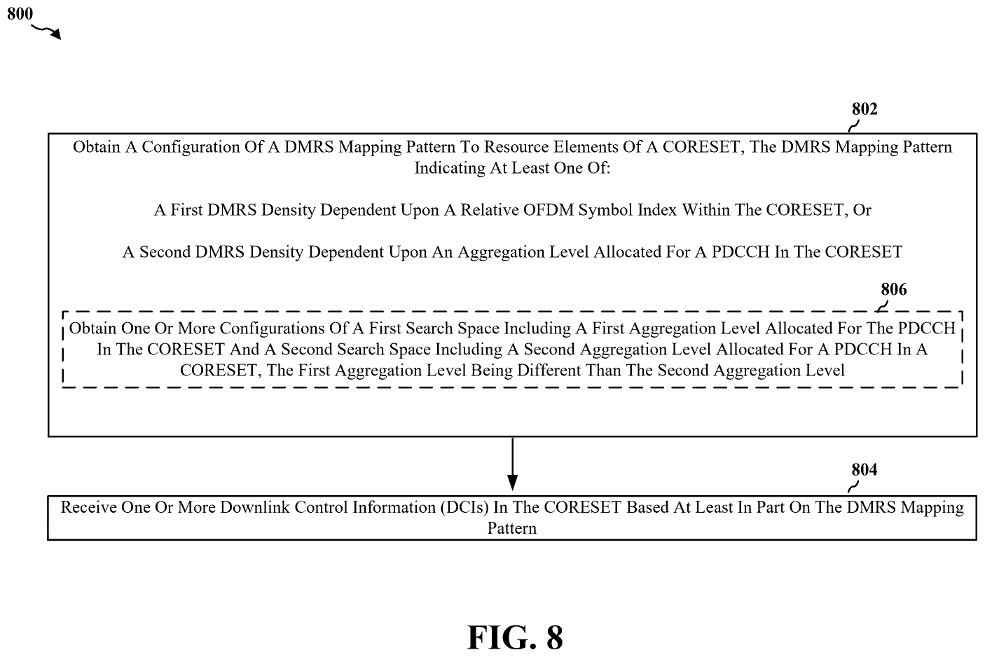

After transmitting the configuration(s) 702 to the UE, the base station 102 may transmit one or more DCIs 716 in a PDCCH 718 in the CORESET 708, and the UE 104 may receive the one or more DCIs 716 in the PDCCH 718 in the CORESET 708. For instance, the base station 102 may transmit, and the UE 104 may receive, the DCI(s) 716 in the CORESET 502, 602 based at least in part on the indicated, DMRS mapping pattern 704. For example, the UE 104 may first use the DMRS mapping pattern 704 to identify the location and density of DMRS 504, 604 in a received signal. If the DMRS detection indicates that there is no DCI 716 present, the UE may stop the decoding or PDCCH monitoring process early, saving power. If the DMRS 504, 604 is detected, the UE may then proceed to decode the PDCCH 718, using the DMRS 504, 604 for channel estimation to reverse the effects of the channel on the received signal and recover the original signal, which includes the DCI 716. This allows the UE to reduce the number of blind decoding candidates of PDCCH 718, leading to significant power savings. Afterwards, the base station 102 may transmit to the UE 104 downlink data 720 scheduled or activated by DCI(s) 716, or the UE 104 may transmit to the base station 102 uplink data 722 scheduled or activated by DCI(s) 716. FIG. 8 is a flowchart 800 of a method of wireless communication. The method may be performed by a UE or one or more of its components, for example, the UE 104, 350; one or more of RX processor(s) 356, TX processor(s) 368, or controller(s)/processor(s) 359; the apparatus 1002; or cellular baseband processor(s) 1004 or its components. Optional aspects are illustrated in dashed lines. The method allows a UE to efficiently decode the PDCCH by using a variable density DMRS mapping pattern, thereby reducing the number of blind decoding candidates, saving power, and improving overall performance and efficiency.

At block 802, the UE may obtain a configuration of a DMRS mapping pattern to resource elements of a CORESET. In one example, the configuration of the DMRS mapping pattern may be obtained semi-statically in a RRC configuration. In another example, the configuration of the DMRS mapping pattern may be obtained dynamically in a MAC-CE or a DCI. The DMRS mapping pattern indicates at least one of: a first DMRS density dependent upon a relative OFDM symbol index within the CORESET, or a second DMRS density dependent upon an aggregation level allocated for a PDCCH in the CORESET. For example, block 802 may be performed by configuration component 1040. Obtaining the configuration may include, for example, receiving, demodulating, and decoding an encoded and modulated signal including the configuration using one or more of RX processor(s) 356 or controller(s)/processor(s) 359 such as described with respect to UE 350 in FIG. 3. For instance, referring to the Figures, the UE 104, 350 may receive configuration 702 of DMRS mapping pattern 704 from base station 102, 310. The configuration 702 may be received in RRC configuration 706, MAC-CE 712, or DCI 714. The pattern 704 may indicate how DMRS 504, 604 are mapped to REs of CORESET 502, 602, 708, such as illustrated in the examples of FIGS. 5 and 6. In one example, the DMRS mapping pattern 704 may indicate a first DMRS density that depends upon the OFDM symbol index 406 of CORESET 502 including DMRS 504, such as DMRS density 506, 508, or 510. The OFDM symbol indices 406 may be relative OFDM symbol indices within CORESET 502 such as any of index ‘0’, ‘1’, ‘2’ or whichever other index begins the CORESET or is subsequent to an index beginning the CORESET, as opposed to an absolute OFDM symbol index of CORESET 502 such as only index ‘0’, only index ‘1’, or the like. In another example, the DMRS mapping pattern 704 may indicate a second DMRS density that depends upon the aggregation level 612, 662 allocated for PDCCH 405 in CORESET 602, 652, such as DMRS density 606, 608, 610, 656, 658, or 660.

At block 804, the UE may receive one or more DCIs in the CORESET based at least in part on the DMRS mapping pattern. For example, block 804 may be performed by DCI component 1042. Receiving the one or more DCIs may include, for example, decoding PDCCH including the one or more DCIs in the CORESET using one or more of RX processor(s) 356 or controller(s)/processor(s) 359 such as described with respect to UE 350 in FIG. 3. For instance, referring to the Figures, the UE 104, 350 may first use the DMRS mapping pattern 704 to identify the location and density of DMRS 504, 604 in a received signal. The DMRS, being a type of reference signal, helps the UE in channel estimation and equalization, processes that characterize the effect of the physical channel on the transmitted signal and reverse these effects to recover the original signal. The UE may use the DMRS mapping pattern 704 when decoding the PDCCH 405 to receive the DCI(s) 716 in CORESET 502, 602, 708. For instance, the UE 104, 350 may perform early detection or absence of PDCCH 718 based on the variable density DMRS. If the DMRS detection indicates that there is no DCI 716 present, the UE may stop the decoding or PDCCH monitoring process early, saving power. If the DMRS is detected, the UE may then proceed to decode the PDCCH 718, using the DMRS for channel estimation to reverse the effects of the channel on the received signal and recover the original signal, which includes the DCI 716.

In one example, the first DMRS density may be associated with an initial relative OFDM symbol index in the CORESET, a third DMRS density may be associated with at least one subsequent relative OFDM symbol index in the CORESET, and the first DMRS density may be greater than the third DMRS density. For instance, referring to FIG. 5, DMRS density 506 corresponding to the first DMRS density may be mapped to OFDM symbol index ‘0’ or other initial relative symbol index in CORESET 502, while DMRS density 510 corresponding to the third DMRS density may be mapped to subsequent OFDM symbol index ‘1’ or ‘2’ or both or other subsequent relative symbol index or indices in CORESET 502. In such case, DMRS density 506 may have a greater or higher density than DMRS density 508, 510. For instance, DMRS density 506 may have a smaller or lesser comb size than DMRS density 508, 510 such as illustrated in FIG. 5.

In one example, the at least one subsequent relative OFDM symbol index may include a plurality of relative OFDM symbol indices, and the third DMRS density may be commonly associated with the plurality of relative OFDM symbol indices. For instance, referring to FIG. 5, DMRS density 510 corresponding to the third DMRS density may be commonly mapped to subsequent OFDM symbol indices ‘1’ and ‘2’ or other subsequent relative symbol indices within CORESET 502. In such case, DMRS density 508 may have a same comb size as DMRS density 510.

In one example, the at least one subsequent relative OFDM symbol index may include a first relative OFDM symbol index and a second relative OFDM symbol index subsequent in time to the first relative OFDM symbol index, the third DMRS density may be associated with the first relative OFDM symbol index, and a fourth DMRS density less than the third DMRS density may be associated with the second relative OFDM symbol index. For instance, referring to FIG. 5, DMRS density 508 corresponding to the third DMRS density may be mapped to OFDM symbol index ‘1’ or other OFDM symbol index corresponding to the first subsequent relative OFDM symbol index, while DMRS density 510 corresponding to the fourth DMRS density may be mapped to OFDM symbol index ‘2’ or other OFDM symbol index corresponding to the second subsequent relative OFDM symbol index. In such case, DMRS density 508 may have a smaller or lesser comb size than DMRS density 510 such as illustrated in FIG. 5.

In one example, the second DMRS density may be associated with a first aggregation level allocated for the PDCCH in the CORESET, a third DMRS density may be associated with a second aggregation level allocated for a PDCCH in a CORESET, the second DMRS density may be greater than the third DMRS density, and the first aggregation level may be less than the second aggregation level. For instance, referring to FIG. 6, DMRS density 606 corresponding to the second DMRS density may be mapped to aggregation level 612 such as AL 2 allocated for PDCCH 405 in CORESET 602, while DMRS density 656 corresponding to the third DMRS density may be mapped to aggregation level 662 such as AL 4 allocated for PDCCH 405 in CORESET 652. In such case, DMRS density 606 may have a smaller or lesser comb size and thus be greater than DMRS density 656 such as illustrated in FIG. 6, while aggregation level 612 such as AL 2 may have a smaller AL than aggregation level 662 such as AL 4.

In one example, the second DMRS density may be associated with an initial relative OFDM symbol index in the CORESET, a fourth DMRS density may be associated with at least one subsequent relative OFDM symbol index in the CORESET, and the second DMRS density may be greater than the fourth DMRS density. For instance, referring to FIG. 5, DMRS density 606 corresponding to the second DMRS density may be mapped to OFDM symbol index ‘0’ or other initial relative symbol index within CORESET 602, while DMRS density 608, 610 corresponding to the fourth DMRS density may be mapped to subsequent OFDM symbol index ‘1’ or ‘2’ or both or other subsequent symbol index or indices within CORESET 602. In such case, DMRS density 606 may have a greater or higher density than DMRS density 608, 610. For instance, DMRS density 606 may have a smaller or lesser comb size than DMRS density 608, 610 such as illustrated in FIG. 6.

In one example, the second DMRS density may be based on a mapping table associating DMRS densities with aggregation levels and relative OFDM symbol indices. For instance, referring to FIG. 6, DMRS density 606 corresponding to the second DMRS density may be configured in mapping table 630, which may map DMRS densities 606, 608, 610, 656, 658, 660 to different aggregation levels 612, 662 and OFDM symbol indices for CORESET 602, 652.

At block 806, the UE may obtain one or more configurations of a first search space including a first aggregation level allocated for the PDCCH in the CORESET and a second search space including a second aggregation level allocated for a PDCCH in a CORESET, the first aggregation level being different than the second aggregation level. For example, block 806 may be performed by configuration component 1040. Obtaining the one or more configurations may include, for example, receiving, demodulating, and decoding an encoded and modulated signal including the configuration using one or more of RX processor(s) 356 or controller(s)/processor(s) 359 such as described with respect to UE 350 in FIG. 3. For instance, referring to the Figures, the UE 104, 350 may receive configuration(s) 702 of search spaces 614, 664, 710 in either the same configuration(s) as DMRS mapping pattern 704 at block 802 or in separate configuration(s). Search space 614 may include aggregation level 612 corresponding to the first AL allocated for PDCCH 405 in CORESET 602, while search space 664 may include aggregation level 662 corresponding to the second AL allocated for PDCCH 405 in CORESET 652. Aggregation level 612, such as AL 2 illustrated in FIG. 6, may be different than aggregation level 662, such as AL 4 illustrated in FIG. 6. Moreover, the second DMRS density may be based on the aggregation level that is a minimum between the first aggregation level and the second aggregation level. For instance, referring to FIG. 6, DMRS density 656 corresponding to the second DMRS density in this example may be mapped to AL 2 rather than AL 4, and thus have the same DMRS density as DMRS density 606 in this example, since AL 2 is the minimum AL between aggregation level 612 and aggregation level 662 and since each aggregation level is included in a different one of search spaces 614, 664, 710.

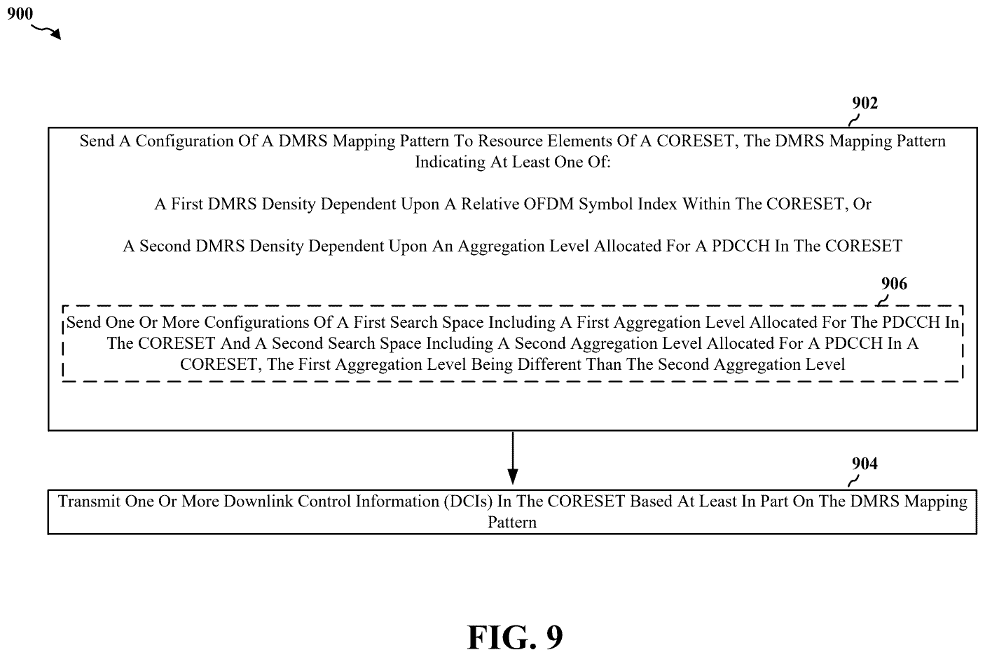

FIG. 9 is a flowchart 900 of a method of wireless communication. The method may be performed by a network entity such as a base station or one or more of its components, for example, the base station 102/180, 310; disaggregated base station 181 or one or more of its components; one or more of RX processor(s) 370, TX processor(s) 316, or controller(s)/processor(s) 375; the apparatus 1102; or baseband unit(s) 1104 or its components. Optional aspects are illustrated in dashed lines. The method allows a network entity to transmit control information to a UE using a variable density DMRS mapping pattern, thereby optimizing the balance between power consumption and channel estimation accuracy and enhancing the overall performance and efficiency of the 5G NR system.

At block 902, the network entity may send a configuration of a DMRS mapping pattern to resource elements of a CORESET. In one example, the configuration of the DMRS mapping pattern may be sent semi-statically in a RRC configuration. In another example, the configuration of the DMRS mapping pattern may be sent dynamically in a MAC-CE or a DCI. The DMRS mapping pattern indicates at least one of: a first DMRS density dependent upon a relative OFDM symbol index within the CORESET, or a second DMRS density dependent upon an aggregation level allocated for a PDCCH in the CORESET. For example, block 902 may be performed by configuration component 1140. Sending the configuration may include, for example, transmitting, modulating, and encoding the configuration using one or more of the TX processor(s) 316 or controller(s)/processor(s) 375, such as described with respect to BS 310 in FIG. 3. For instance, referring to the Figures, the base station 102, 310 may transmit configuration 702 of DMRS mapping pattern 704 to UE 104, 350. The configuration 702 may be transmitted in RRC configuration 706, MAC-CE 712, or DCI 714. The pattern 704 may indicate how DMRS 504, 604 are mapped to REs of CORESET 502, 602, 708, such as illustrated in the examples of FIGS. 5 and 6. In one example, the DMRS mapping pattern 704 may indicate a first DMRS density that depends upon the OFDM symbol index 406 of CORESET 502 including DMRS 504, such as DMRS density 506, 508, or 510. The OFDM symbol indices 406 may be relative OFDM symbol indices within CORESET 502 such as any of index ‘0’, ‘1’, ‘2’ or whichever other index begins the CORESET or is subsequent to an index beginning the CORESET, as opposed to an absolute OFDM symbol index of CORESET 502 such as only index ‘0’, only index ‘1’, or the like. In another example, the DMRS mapping pattern 704 may indicate a second DMRS density that depends upon the aggregation level 612, 662 allocated for PDCCH 405 in CORESET 602, 652, such as DMRS density 606, 608, 610, 656, 658, or 660.

At block 904, the network entity transmits one or more DCIs in the CORESET based at least in part on the DMRS mapping pattern. For example, block 904 may be performed by DCI component 1142. Transmitting the one or more DCIs may include, for example, encoding PDCCH including the one or more DCIs in the CORESET using one or more of the TX processor(s) 316 or controller(s)/processor(s) 375, such as described with respect to BS 310 in FIG. 3. For instance, referring to the Figures, the base station 102, 310 may first use the DMRS mapping pattern 704 to determine the location and density of DMRS 504, 604 in a signal to be transmitted. The base station may use the DMRS mapping pattern 704 when encoding the PDCCH 405 to transmit the DCI(s) 716 in CORESET 502, 602, 708. For instance, the base station 102, 310 may configure variable density DMRS in the CORESET to allow UE to perform early detection or absence of PDCCH. By adjusting the DMRS density based on the symbol position within the CORESET or the aggregation level allocated for a PDCCH in the CORESET, the base station can optimize the balance between power consumption and channel estimation accuracy, leading to improved performance and efficiency of the 5G NR system.

In one example, the first DMRS density may be associated with an initial relative OFDM symbol index in the CORESET, a third DMRS density may be associated with at least one subsequent relative OFDM symbol index in the CORESET, and the first DMRS density may be greater than the third DMRS density. For instance, referring to FIG. 5, DMRS density 506 corresponding to the first DMRS density may be mapped to OFDM symbol index ‘0’ or other initial relative symbol index in CORESET 502, while DMRS density 510 corresponding to the third DMRS density may be mapped to subsequent OFDM symbol index ‘1’ or ‘2’ or both or other subsequent relative symbol index or indices in CORESET 502. In such case, DMRS density 506 may have a greater or higher density than DMRS density 508, 510. For instance, DMRS density 506 may have a smaller or lesser comb size than DMRS density 508, 510 such as illustrated in FIG. 5.

In one example, the at least one subsequent relative OFDM symbol index may include a plurality of relative OFDM symbol indices, and the third DMRS density may be commonly associated with the plurality of relative OFDM symbol indices. For instance, referring to FIG. 5, DMRS density 510 corresponding to the third DMRS density may be commonly mapped to subsequent OFDM symbol indices ‘1’ and ‘2’ or other subsequent relative symbol indices within CORESET 502. In such case, DMRS density 508 may have a same comb size as DMRS density 510.

In one example, the at least one subsequent relative OFDM symbol index may include a first relative OFDM symbol index and a second relative OFDM symbol index subsequent in time to the first relative OFDM symbol index, the third DMRS density may be associated with the first relative OFDM symbol index, and a fourth DMRS density less than the third DMRS density may be associated with the second relative OFDM symbol index. For instance, referring to FIG. 5, DMRS density 508 corresponding to the third DMRS density may be mapped to OFDM symbol index ‘1’ or other OFDM symbol index corresponding to the first subsequent relative OFDM symbol index, while DMRS density 510 corresponding to the fourth DMRS density may be mapped to OFDM symbol index ‘2’ or other OFDM symbol index corresponding to the second subsequent relative OFDM symbol index. In such case, DMRS density 508 may have a smaller or lesser comb size than DMRS density 510 such as illustrated in FIG. 5.

In one example, the second DMRS density may be associated with a first aggregation level allocated for the PDCCH in the CORESET, a third DMRS density may be associated with a second aggregation level allocated for a PDCCH in a CORESET, the second DMRS density may be greater than the third DMRS density, and the first aggregation level may be less than the second aggregation level. For instance, referring to FIG. 6, DMRS density 606 corresponding to the second DMRS density may be mapped to aggregation level 612 such as AL 2 allocated for PDCCH 405 in CORESET 602, while DMRS density 656 corresponding to the third DMRS density may be mapped to aggregation level 662 such as AL 4 allocated for PDCCH 405 in CORESET 652. In such case, DMRS density 606 may have a smaller or lesser comb size and thus be greater than DMRS density 656 such as illustrated in FIG. 6, while aggregation level 612 such as AL 2 may have a smaller AL than aggregation level 662 such as AL 4.

In one example, the second DMRS density may be associated with an initial relative OFDM symbol index in the CORESET, a fourth DMRS density may be associated with at least one subsequent relative OFDM symbol index in the CORESET, and the second DMRS density may be greater than the fourth DMRS density. For instance, referring to FIG. 5, DMRS density 606 corresponding to the second DMRS density may be mapped to OFDM symbol index ‘0’ or other initial relative symbol index within CORESET 602, while DMRS density 608, 610 corresponding to the fourth DMRS density may be mapped to subsequent OFDM symbol index ‘1’ or ‘2’ or both or other subsequent symbol index or indices within CORESET 602. In such case, DMRS density 606 may have a greater or higher density than DMRS density 608, 610. For instance, DMRS density 606 may have a smaller or lesser comb size than DMRS density 608, 610 such as illustrated in FIG. 6.

In one example, the second DMRS density may be based on a mapping table associating DMRS densities with aggregation levels and relative OFDM symbol indices. For instance, referring to FIG. 6, DMRS density 606 corresponding to the second DMRS density may be configured in mapping table 630, which may map DMRS densities 606, 608, 610, 656, 658, 660 to different aggregation levels 612, 662 and OFDM symbol indices for CORESET 602, 652.

At block 906, the network entity may send one or more configurations of a first search space including a first aggregation level allocated for the PDCCH in the CORESET and a second search space including a second aggregation level allocated for a PDCCH in a CORESET, the first aggregation level being different than the second aggregation level. For example, block 906 may be performed by configuration component 1140. Sending the one or more configurations may include, for example, transmitting, modulating, and encoding the configuration using one or more of the TX processor(s) 316 or controller(s)/processor(s) 375, such as described with respect to BS 310 in FIG. 3. For instance, referring to the Figures, the base station 102, 310 may transmit configuration(s) 702 of search spaces 614, 664, 710 in either the same configuration(s) as DMRS mapping pattern 704 at block 802 or in separate configuration(s). Search space 614 may include aggregation level 612 corresponding to the first AL allocated for PDCCH 405 in CORESET 602, while search space 664 may include aggregation level 662 corresponding to the second AL allocated for PDCCH 405 in CORESET 652. Aggregation level 612, such as AL 2 illustrated in FIG. 6, may be different than aggregation level 662, such as AL 4 illustrated in FIG. 6. Moreover, the second DMRS density may be based on the aggregation level that is a minimum between the first aggregation level and the second aggregation level. For instance, referring to FIG. 6, DMRS density 656 corresponding to the second DMRS density in this example may be mapped to AL 2 rather than AL 4, and thus have the same DMRS density as DMRS density 606 in this example, since AL 2 is the minimum AL between aggregation level 612 and aggregation level 662 and since each aggregation level is included in a different one of search spaces 614, 664, 710.

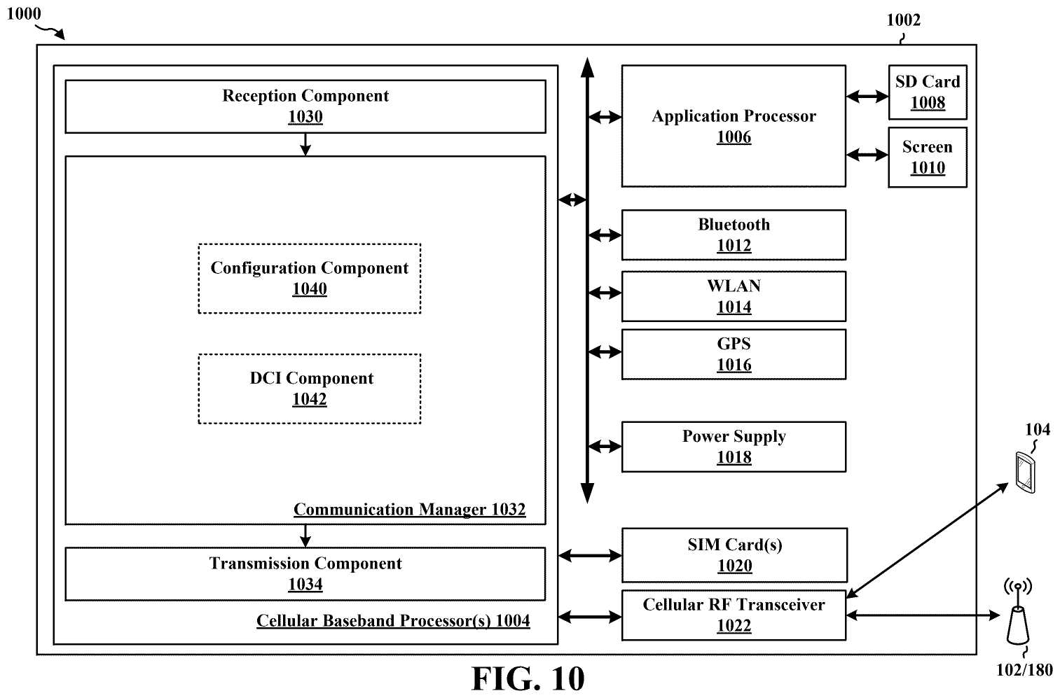

FIG. 10 is a diagram 1000 illustrating an example of a hardware implementation for an apparatus 1002. The apparatus 1002 is a UE and includes one or more cellular baseband processors 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The one or more cellular baseband processors 1004 communicate through the cellular RF transceiver 1022 with the BS 102/180/disaggregated base station 181. For example, the cellular RF transceiver 1022 may correspond to or include the transmitters 354TX, receivers 354RX, and antennas 352 of UE 350.

The one or more cellular baseband processors 1004 may each include a computer-readable medium/one or more memories. The computer-readable medium/one or more memories may be non-transitory. The one or more cellular baseband processors 1004 are responsible for general processing, including the execution of software stored on the computer-readable medium/one or more memories individually or in combination. The software, when executed by the one or more cellular baseband processors 1004, causes the one or more cellular baseband processors 1004 to, individually or in combination, perform the various functions described supra. The computer-readable medium/one or more memories may also be used individually or in combination for storing data that is manipulated by the one or more cellular baseband processors 1004 when executing software. The one or more cellular baseband processors 1004 individually or in combination further include a reception component 1030, a communication manager 1032, and a transmission component 1034. The communication manager 1032 includes the one or more illustrated components. The components within the communication manager 1032 may be stored in the computer-readable medium/one or more memories and/or configured as hardware within the one or more cellular baseband processors 1004. The one or more cellular baseband processors 1004 may be components of the UE 350 and may individually or in combination include the one or more memories 360 and/or at least one of the one or more TX processors 368, at least one of the one or more RX processors 356, and at least one of the one or more controllers/processors 359. For example, the reception component 1030 may include at least the one or more RX processors 356, the transmission component 1034 may include at least the one or more TX processors 368, and the communication manager 1032 may include at least the one or more controllers/processors 359. In one configuration, the apparatus 1002 may be a modem chip and include just the one or more baseband processors 1004, and in another configuration, the apparatus 1002 may be the entire UE (e.g., see 350 of FIG. 3) and include the aforediscussed additional modules of the apparatus 1002.

The communication manager 1032 includes a configuration component 1040 that is configured to obtain, for example via reception component 1030, a configuration of a DMRS mapping pattern to resource elements of a CORESET, the DMRS mapping pattern indicating at least one of: a first DMRS density dependent upon a relative OFDM symbol index within the CORESET, or a second DMRS density dependent upon an aggregation level allocated for a PDCCH in the CORESET, such as described in connection with block 802. The communication manager 1032 may further include a DCI component 1042 that is configured to receive, for example via reception component 1030, one or more DCIs in the CORESET based at least in part on the DMRS mapping pattern, such as described in connection with block 804. The configuration component 1040 may be further configured to obtain, for example via reception component 1030, one or more configurations of a first search space including a first aggregation level allocated for the PDCCH in the CORESET and a second search space including a second aggregation level allocated for a PDCCH in a CORESET, the first aggregation level being different than the second aggregation level, such as described in connection with block 806.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1002, and in particular the one or more cellular baseband processors 1004, includes means for obtaining a configuration of a DMRS mapping pattern to resource elements of a CORESET, the DMRS mapping pattern indicating at least one of: a first DMRS density dependent upon a relative OFDM symbol index within the CORESET, or a second DMRS density dependent upon an aggregation level allocated for a PDCCH in the CORESET. The apparatus 1002, and in particular the one or more cellular baseband processors 1004, further includes means for receiving one or more DCIs in the CORESET based at least in part on the DMRS mapping pattern. In one configuration, the means for obtaining may further be configured to obtain one or more configurations of a first search space including a first aggregation level allocated for the PDCCH in the CORESET and a second search space including a second aggregation level allocated for a PDCCH in a CORESET, the first aggregation level being different than the second aggregation level.

The aforementioned means may be one or more of the aforementioned components of the apparatus 1002 configured to perform the functions recited by the aforementioned means. As described supra, the apparatus 1002 may include the one or more TX Processors 368, the one or more RX Processors 356, and the one or more controllers/processors 359. As such, in one configuration, the aforementioned means may be at least one of the one or more TX Processors 368, at least one of the one or more RX Processors 356, or at least one of the one or more controllers/processors 359, individually or in any combination configured to perform the functions recited by the aforementioned means.

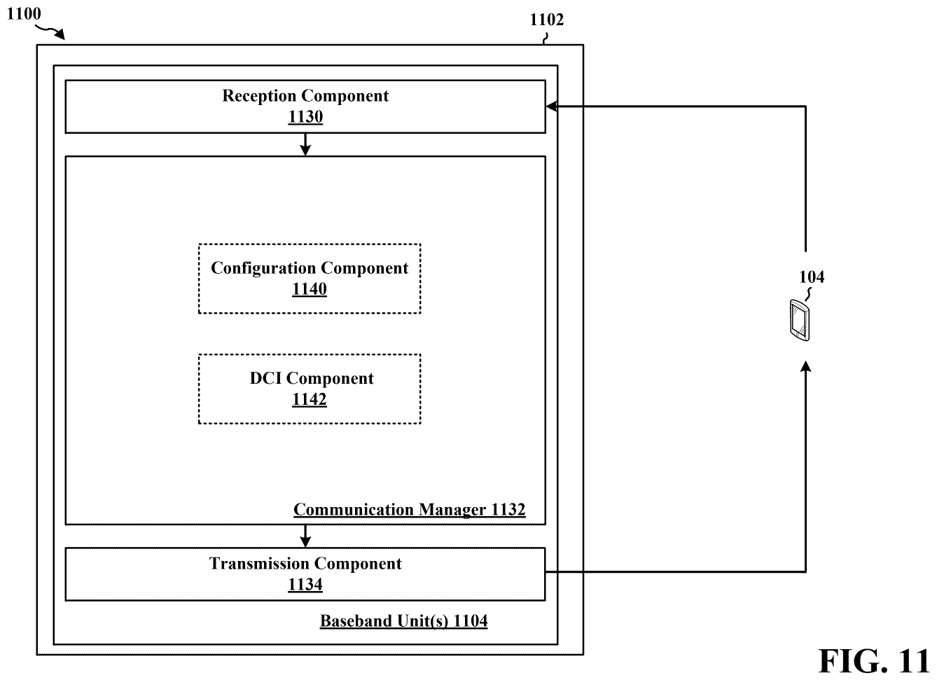

FIG. 11 is a diagram 1100 illustrating an example of a hardware implementation for an apparatus 1102. The apparatus 1102 is a network entity such as a base station and includes one or more baseband units 1104. The one or more baseband units 1104 communicate through a cellular RF transceiver with the UE 104. For example, the cellular RF transceiver may correspond to or include the transmitters 318TX, receivers 318RX, and antennas 320 of base station 310.

The one or more baseband units 1104 may each include a computer-readable medium/one or more memories. The computer-readable medium/one or more memories may be non-transitory. The one or more baseband units 1104 are responsible for general processing, including the execution of software stored on the computer-readable medium/one or more memories individually or in combination. The software, when executed by the one or more baseband units 1104, causes the one or more baseband units 1104 to, individually or in combination, perform the various functions described supra. The computer-readable medium/one or more memories may also be used individually or in combination for storing data that is manipulated by the one or more baseband units 1104 when executing software. The one or more baseband units 1104 individually or in combination further include a reception component 1130, a communication manager 1132, and a transmission component 1134. The communication manager 1132 includes the one or more illustrated components. The components within the communication manager 1132 may be stored in the computer-readable medium/one or more memories and/or configured as hardware within the one or more baseband units 1104. The one or more baseband units 1104 may be components of the BS 310 and may individually or in combination include the one or more memories 376 and/or at least one of the one or more TX processors 316, at least one of the one or more RX processors 370, and at least one of the one or more controllers/processors 375. For example, the reception component 1130 may include at least the one or more RX processors 370, the transmission component 1134 may include at least the one or more TX processors 316, and the communication manager 1132 may include at least the one or more controllers/processors 375.

The communication manager 1132 includes a configuration component 1140 that is configured to send, for example via transmission component 1134, a configuration of a DMRS mapping pattern to resource elements of a CORESET, the DMRS mapping pattern indicating at least one of: a first DMRS density dependent upon a relative OFDM symbol index within the CORESET, or a second DMRS density dependent upon an aggregation level allocated for a PDCCH in the CORESET, such as described in connection with block 902. The communication manager 1132 may further include a DCI component 1142 that is configured to transmit, for example via transmission component 1134, one or more DCIs in the CORESET based at least in part on the DMRS mapping pattern, such as described in connection with block 904. The configuration component 1140 may be further configured to send, for example via transmission component 1134, one or more configurations of a first search space including a first aggregation level allocated for the PDCCH in the CORESET and a second search space including a second aggregation level allocated for a PDCCH in a CORESET, the first aggregation level being different than the second aggregation level, such as described in connection with block 906.

The apparatus may include additional components that perform each of the blocks of the algorithm in the aforementioned flowchart of FIG. 9. As such, each block in the aforementioned flowchart of FIG. 9 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1102, and in particular the one or more baseband units 1104, includes means for sending a configuration of a DMRS mapping pattern to resource elements of a CORESET, the DMRS mapping pattern indicating at least one of: a first DMRS density dependent upon a relative OFDM symbol index within the CORESET, or a second DMRS density dependent upon an aggregation level allocated for a PDCCH in the CORESET. The apparatus 1102, and in particular the one or more baseband units 1104, further includes means for transmitting one or more DCIs in the CORESET based at least in part on the DMRS mapping pattern. In one configuration, the means for sending may further be configured to send one or more configurations of a first search space including a first aggregation level allocated for the PDCCH in the CORESET and a second search space including a second aggregation level allocated for a PDCCH in a CORESET, the first aggregation level being different than the second aggregation level.

The aforementioned means may be one or more of the aforementioned components of the apparatus 1102 configured to perform the functions recited by the aforementioned means. As described supra, the apparatus 1102 may include the one or more TX Processors 316, the one or more RX Processors 370, and the one or more controllers/processors 375. As such, in one configuration, the aforementioned means may be at least one of the one or more TX Processors 316, at least one of the one or more RX Processors 370, or at least one of the one or more controllers/processors 375, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: obtain a configuration of a demodulation reference signal (DMRS) mapping pattern to resource elements of a control resource set (CORESET), the DMRS mapping pattern indicating at least one of: a first DMRS density dependent upon a relative orthogonal frequency division multiplexing (OFDM) symbol index within the CORESET, or a second DMRS density dependent upon an aggregation level allocated for a physical downlink control channel (PDCCH) in the CORESET; and receive one or more downlink control information (DCIs) in the CORESET based at least in part on the DMRS mapping pattern.

Clause 2. The apparatus of clause 1, wherein the first DMRS density is associated with an initial relative OFDM symbol index within the CORESET, a third DMRS density is associated with at least one subsequent relative OFDM symbol index within the CORESET, and the first DMRS density is greater than the third DMRS density.

Clause 3. The apparatus of clause 2, wherein the at least one subsequent relative OFDM symbol index includes a plurality of relative OFDM symbol indices, and the third DMRS density is commonly associated with the plurality of relative OFDM symbol indices.

Clause 4. The apparatus of clause 2, wherein the at least one subsequent relative OFDM symbol index includes a first relative OFDM symbol index and a second relative OFDM symbol index subsequent in time to the first relative OFDM symbol index, the third DMRS density is associated with the first relative OFDM symbol index, and a fourth DMRS density less than the third DMRS density is associated with the second relative OFDM symbol index.

Clause 5. The apparatus of any of clauses 1 to 4, wherein the second DMRS density is associated with a first aggregation level allocated for the PDCCH in the CORESET, a third DMRS density is associated with a second aggregation level allocated for a PDCCH in a CORESET, the second DMRS density is greater than the third DMRS density, and the first aggregation level is less than the second aggregation level.

Clause 6. The apparatus of clause 5, wherein the second DMRS density is associated with an initial relative OFDM symbol index within the CORESET, a fourth DMRS density is associated with at least one subsequent relative OFDM symbol index within the CORESET, and the second DMRS density is greater than the fourth DMRS density.

Clause 7. The apparatus of clause 5 or clause 6, wherein the second DMRS density is based on a mapping table associating DMRS densities with aggregation levels and relative OFDM symbol indices.

Clause 8. The apparatus of any of clauses 1 to 7, wherein the one or more processors, individually or in any combination, are operable to cause the apparatus to: obtain one or more configurations of a first search space including a first aggregation level allocated for the PDCCH in the CORESET and a second search space including a second aggregation level allocated for a PDCCH in a CORESET, the first aggregation level being different than the second aggregation level, wherein the second DMRS density is based on the aggregation level that is a minimum between the first aggregation level and the second aggregation level.

Clause 9. The apparatus of any of clauses 1 to 8, wherein the configuration of the DMRS mapping pattern is obtained semi-statically in a radio resource control (RRC) configuration.

Clause 10. The apparatus of any of clauses 1 to 8, wherein the configuration of the DMRS mapping pattern is obtained dynamically in a medium access control (MAC) control element (MAC-CE) or a DCI.

Clause 11. A method of wireless communication performable at a user equipment (UE), comprising: obtaining a configuration of a demodulation reference signal (DMRS) mapping pattern to resource elements of a control resource set (CORESET), the DMRS mapping pattern indicating at least one of: a first DMRS density dependent upon a relative orthogonal frequency division multiplexing (OFDM) symbol index within the CORESET, or a second DMRS density dependent upon an aggregation level allocated for a physical downlink control channel (PDCCH) in the CORESET; and receiving one or more downlink control information (DCIs) in the CORESET based at least in part on the DMRS mapping pattern.

Clause 12. The method of clause 11, wherein the first DMRS density is associated with an initial relative OFDM symbol index within the CORESET, a third DMRS density is associated with at least one subsequent relative OFDM symbol index within the CORESET, and the first DMRS density is greater than the third DMRS density.

Clause 13. The method of clause 11 or clause 12, wherein the second DMRS density is associated with a first aggregation level allocated for the PDCCH in the CORESET, a third DMRS density is associated with a second aggregation level allocated for a PDCCH in a CORESET, the second DMRS density is greater than the third DMRS density, and the first aggregation level is less than the second aggregation level.

Clause 14. The method of any of clauses 11 to 13, further comprising: obtaining one or more configurations of a first search space including a first aggregation level allocated for the PDCCH in the CORESET and a second search space including a second aggregation level allocated for a PDCCH in a CORESET, the first aggregation level being different than the second aggregation level, wherein the second DMRS density is based on the aggregation level that is a minimum between the first aggregation level and the second aggregation level.

Clause 15. The method of any of clauses 11 to 14, wherein the configuration of the DMRS mapping pattern is obtained: semi-statically in a radio resource control (RRC) configuration, or dynamically in a medium access control (MAC) control element (MAC-CE) or a DCI.

Clause 16. An apparatus for wireless communication, comprising: one or more memories; and one or more processors each communicatively coupled with at least one of the one or more memories, the one or more processors, individually or in any combination, operable to cause the apparatus to: send a configuration of a demodulation reference signal (DMRS) mapping pattern to resource elements of a control resource set (CORESET), the DMRS mapping pattern indicating at least one of: a first DMRS density dependent upon a relative orthogonal frequency division multiplexing (OFDM) symbol index within the CORESET, or a second DMRS density dependent upon an aggregation level allocated for a physical downlink control channel (PDCCH) in the CORESET; and transmit one or more downlink control information (DCIs) in the CORESET based at least in part on the DMRS mapping pattern.

Clause 17. The apparatus of clause 16, wherein the first DMRS density is associated with an initial relative OFDM symbol index within the CORESET, a third DMRS density is associated with at least one subsequent relative OFDM symbol index within the CORESET, and the first DMRS density is greater than the third DMRS density.

Clause 18. The apparatus of clause 17, wherein the at least one subsequent relative OFDM symbol index includes a plurality of relative OFDM symbol indices, and the third DMRS density is commonly associated with the plurality of relative OFDM symbol indices.

Clause 19. The apparatus of clause 17, wherein the at least one subsequent relative OFDM symbol index includes a first relative OFDM symbol index and a second relative OFDM symbol index subsequent in time to the first relative OFDM symbol index, the third DMRS density is associated with the first relative OFDM symbol index, and a fourth DMRS density less than the third DMRS density is associated with the second relative OFDM symbol index.

Clause 20. The apparatus of any of clauses 16 to 19, wherein the second DMRS density is associated with a first aggregation level allocated for the PDCCH in the CORESET, a third DMRS density is associated with a second aggregation level allocated for a PDCCH in a CORESET, the second DMRS density is greater than the third DMRS density, and the first aggregation level is less than the second aggregation level.

Clause 21. The apparatus of clause 20, wherein the second DMRS density is associated with an initial relative OFDM symbol index within the CORESET, a fourth DMRS density is associated with at least one subsequent relative OFDM symbol index within the CORESET, and the second DMRS density is greater than the fourth DMRS density.

Clause 22. The apparatus of clause 20 or clause 21, wherein the second DMRS density is based on a mapping table associating DMRS densities with aggregation levels and relative OFDM symbol indices.

Clause 23. The apparatus of any of clauses 16 to 22, wherein the one or more processors, individually or in any combination, are operable to cause the apparatus to: send one or more configurations of a first search space including a first aggregation level allocated for the PDCCH in the CORESET and a second search space including a second aggregation level allocated for a PDCCH in a CORESET, the first aggregation level being different than the second aggregation level, wherein the second DMRS density is based on the aggregation level that is a minimum between the first aggregation level and the second aggregation level.

Clause 24. The apparatus of any of clauses 16 to 23, wherein the configuration of the DMRS mapping pattern is sent semi-statically in a radio resource control (RRC) configuration.

Clause 25. The apparatus of any of clauses 16 to 23, wherein the configuration of the DMRS mapping pattern is sent dynamically in a medium access control (MAC) control element (MAC-CE) or a DCI.

Clause 26. A method of wireless communication performable at a network entity, comprising: sending a configuration of a demodulation reference signal (DMRS) mapping pattern to resource elements of a control resource set (CORESET), the DMRS mapping pattern indicating at least one of: a first DMRS density dependent upon a relative orthogonal frequency division multiplexing (OFDM) symbol index within the CORESET, or a second DMRS density dependent upon an aggregation level allocated for a physical downlink control channel (PDCCH) in the CORESET; and transmitting one or more downlink control information (DCIs) in the CORESET based at least in part on the DMRS mapping pattern.

Clause 27. The method of clause 26, wherein the first DMRS density is associated with an initial relative OFDM symbol index within the CORESET, a third DMRS density is associated with at least one subsequent relative OFDM symbol index within the CORESET, and the first DMRS density is greater than the third DMRS density.

Clause 28. The method of clause 26 or clause 27, wherein the second DMRS density is associated with a first aggregation level allocated for the PDCCH in the CORESET, a third DMRS density is associated with a second aggregation level allocated for a PDCCH in a CORESET, the second DMRS density is greater than the third DMRS density, and the first aggregation level is less than the second aggregation level.

Clause 29. The method of any of clauses 26 to 28, further comprising: sending one or more configurations of a first search space including a first aggregation level allocated for the PDCCH in the CORESET and a second search space including a second aggregation level allocated for a PDCCH in a CORESET, the first aggregation level being different than the second aggregation level, wherein the second DMRS density is based on the aggregation level that is a minimum between the first aggregation level and the second aggregation level.

Clause 30. The method of any of clauses 26 to 29, wherein the configuration of the DMRS mapping pattern is sent: semi-statically in a radio resource control (RRC) configuration, or dynamically in a medium access control (MAC) control element (MAC-CE) or a DCI.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
obtain a configuration of a demodulation reference signal (DMRS) mapping pattern to resource elements of a control resource set (CORESET), the DMRS mapping pattern indicating at least one of:
a first DMRS density dependent upon a relative orthogonal frequency division multiplexing (OFDM) symbol index within the CORESET, or
a second DMRS density dependent upon an aggregation level allocated for a physical downlink control channel (PDCCH) in the CORESET; and
receive one or more downlink control information (DCIs) in the CORESET based at least in part on the DMRS mapping pattern.

2. The apparatus of claim 1, wherein the first DMRS density is associated with an initial relative OFDM symbol index within the CORESET, a third DMRS density is associated with at least one subsequent relative OFDM symbol index within the CORESET, and the first DMRS density is greater than the third DMRS density.

3. The apparatus of claim 2, wherein the at least one subsequent relative OFDM symbol index includes a plurality of relative OFDM symbol indices, and the third DMRS density is commonly associated with the plurality of relative OFDM symbol indices.

4. The apparatus of claim 2, wherein the at least one subsequent relative OFDM symbol index includes a first relative OFDM symbol index and a second relative OFDM symbol index subsequent in time to the first relative OFDM symbol index, the third DMRS density is associated with the first relative OFDM symbol index, and a fourth DMRS density less than the third DMRS density is associated with the second relative OFDM symbol index.

5. The apparatus of claim 1, wherein the second DMRS density is associated with a first aggregation level allocated for the PDCCH in the CORESET, a third DMRS density is associated with a second aggregation level allocated for a PDCCH in a CORESET, the second DMRS density is greater than the third DMRS density, and the first aggregation level is less than the second aggregation level.

6. The apparatus of claim 5, wherein the second DMRS density is associated with an initial relative OFDM symbol index within the CORESET, a fourth DMRS density is associated with at least one subsequent relative OFDM symbol index within the CORESET, and the second DMRS density is greater than the fourth DMRS density.

7. The apparatus of claim 5, wherein the second DMRS density is based on a mapping table associating DMRS densities with aggregation levels and relative OFDM symbol indices.

8. The apparatus of claim 1, wherein the one or more processors, individually or in any combination, are operable to cause the apparatus to:
obtain one or more configurations of a first search space including a first aggregation level allocated for the PDCCH in the CORESET and a second search space including a second aggregation level allocated for a PDCCH in a CORESET, the first aggregation level being different than the second aggregation level,
wherein the second DMRS density is based on the aggregation level that is a minimum between the first aggregation level and the second aggregation level.

9. The apparatus of claim 1, wherein the configuration of the DMRS mapping pattern is obtained semi-statically in a radio resource control (RRC) configuration.

10. The apparatus of claim 1, wherein the configuration of the DMRS mapping pattern is obtained dynamically in a medium access control (MAC) control element (MAC-CE) or a DCI.

11. A method of wireless communication performable at a user equipment (UE), comprising:
obtaining a configuration of a demodulation reference signal (DMRS) mapping pattern to resource elements of a control resource set (CORESET), the DMRS mapping pattern indicating at least one of:
a first DMRS density dependent upon a relative orthogonal frequency division multiplexing (OFDM) symbol index within the CORESET, or
a second DMRS density dependent upon an aggregation level allocated for a physical downlink control channel (PDCCH) in the CORESET; and
receiving one or more downlink control information (DCIs) in the CORESET based at least in part on the DMRS mapping pattern.

12. The method of claim 11, wherein the first DMRS density is associated with an initial relative OFDM symbol index within the CORESET, a third DMRS density is associated with at least one subsequent relative OFDM symbol index within the CORESET, and the first DMRS density is greater than the third DMRS density.

13. The method of claim 11, wherein the second DMRS density is associated with a first aggregation level allocated for the PDCCH in the CORESET, a third DMRS density is associated with a second aggregation level allocated for a PDCCH in a CORESET, the second DMRS density is greater than the third DMRS density, and the first aggregation level is less than the second aggregation level.

14. The method of claim 11, further comprising:
obtaining one or more configurations of a first search space including a first aggregation level allocated for the PDCCH in the CORESET and a second search space including a second aggregation level allocated for a PDCCH in a CORESET, the first aggregation level being different than the second aggregation level,
wherein the second DMRS density is based on the aggregation level that is a minimum between the first aggregation level and the second aggregation level.

15. The method of claim 11, wherein the configuration of the DMRS mapping pattern is obtained:
semi-statically in a radio resource control (RRC) configuration, or
dynamically in a medium access control (MAC) control element (MAC-CE) or a DCI.

16. An apparatus for wireless communication, comprising:
one or more memories; and
one or more processors each communicatively coupled with at least one of the one or more memories, the one or more processors, individually or in any combination, operable to cause the apparatus to:
send a configuration of a demodulation reference signal (DMRS) mapping pattern to resource elements of a control resource set (CORESET), the DMRS mapping pattern indicating at least one of:
a first DMRS density dependent upon a relative orthogonal frequency division multiplexing (OFDM) symbol index within the CORESET, or
a second DMRS density dependent upon an aggregation level allocated for a physical downlink control channel (PDCCH) in the CORESET; and
transmit one or more downlink control information (DCIs) in the CORESET based at least in part on the DMRS mapping pattern.

17. The apparatus of claim 16, wherein the first DMRS density is associated with an initial relative OFDM symbol index within the CORESET, a third DMRS density is associated with at least one subsequent relative OFDM symbol index within the CORESET, and the first DMRS density is greater than the third DMRS density.

18. The apparatus of claim 17, wherein the at least one subsequent relative OFDM symbol index includes a plurality of relative OFDM symbol indices, and the third DMRS density is commonly associated with the plurality of relative OFDM symbol indices.

19. The apparatus of claim 17, wherein the at least one subsequent relative OFDM symbol index includes a first relative OFDM symbol index and a second relative OFDM symbol index subsequent in time to the first relative OFDM symbol index, the third DMRS density is associated with the first relative OFDM symbol index, and a fourth DMRS density less than the third DMRS density is associated with the second relative OFDM symbol index.

20. The apparatus of claim 16, wherein the second DMRS density is associated with a first aggregation level allocated for the PDCCH in the CORESET, a third DMRS density is associated with a second aggregation level allocated for a PDCCH in a CORESET, the second DMRS density is greater than the third DMRS density, and the first aggregation level is less than the second aggregation level.

21. The apparatus of claim 20, wherein the second DMRS density is associated with an initial relative OFDM symbol index within the CORESET, a fourth DMRS density is associated with at least one subsequent relative OFDM symbol index within the CORESET, and the second DMRS density is greater than the fourth DMRS density.

22. The apparatus of claim 20, wherein the second DMRS density is based on a mapping table associating DMRS densities with aggregation levels and relative OFDM symbol indices.

23. The apparatus of claim 16, wherein the one or more processors, individually or in any combination, are operable to cause the apparatus to:
send one or more configurations of a first search space including a first aggregation level allocated for the PDCCH in the CORESET and a second search space including a second aggregation level allocated for a PDCCH in a CORESET, the first aggregation level being different than the second aggregation level,
wherein the second DMRS density is based on the aggregation level that is a minimum between the first aggregation level and the second aggregation level.

24. The apparatus of claim 16, wherein the configuration of the DMRS mapping pattern is sent semi-statically in a radio resource control (RRC) configuration.

25. The apparatus of claim 16, wherein the configuration of the DMRS mapping pattern is sent dynamically in a medium access control (MAC) control element (MAC-CE) or a DCI.

26. A method of wireless communication performable at a network entity, comprising:
sending a configuration of a demodulation reference signal (DMRS) mapping pattern to resource elements of a control resource set (CORESET), the DMRS mapping pattern indicating at least one of:
a first DMRS density dependent upon a relative orthogonal frequency division multiplexing (OFDM) symbol index within the CORESET, or
a second DMRS density dependent upon an aggregation level allocated for a physical downlink control channel (PDCCH) in the CORESET; and
transmitting one or more downlink control information (DCIs) in the CORESET based at least in part on the DMRS mapping pattern.

27. The method of claim 26, wherein the first DMRS density is associated with an initial relative OFDM symbol index within the CORESET, a third DMRS density is associated with at least one subsequent relative OFDM symbol index within the CORESET, and the first DMRS density is greater than the third DMRS density.

28. The method of claim 26, wherein the second DMRS density is associated with a first aggregation level allocated for the PDCCH in the CORESET, a third DMRS density is associated with a second aggregation level allocated for a PDCCH in a CORESET, the second DMRS density is greater than the third DMRS density, and the first aggregation level is less than the second aggregation level.

29. The method of claim 26, further comprising:
sending one or more configurations of a first search space including a first aggregation level allocated for the PDCCH in the CORESET and a second search space including a second aggregation level allocated for a PDCCH in a CORESET, the first aggregation level being different than the second aggregation level,
wherein the second DMRS density is based on the aggregation level that is a minimum between the first aggregation level and the second aggregation level.

30. The method of claim 26, wherein the configuration of the DMRS mapping pattern is sent:
semi-statically in a radio resource control (RRC) configuration, or
dynamically in a medium access control (MAC) control element (MAC-CE) or a DCI.
